(19) United States
(12) Patent Application Publication
(10) Pub. No.: US 2025/0060523 A1
(43) Pub. Date: Feb. 20, 2025

(54) LARGE FIELD-OF-VIEW GEOMETRICAL WAVEGUIDE

(71) Applicant: Meta Platforms Technologies, LLC, Menlo Park, CA (US)

(72) Inventors: Jianbo Zhao, Bothell, WA (US); Miaomiao Xu, Redmond, WA (US); Pei Xiong, Redmond, WA (US); Yu Shi, Redmond, WA (US); Hee Yoon Lee, Palo Alto, CA (US)

(21) Appl. No.: 18/802,924

(22) Filed: Aug. 13, 2024

Related U.S. Application Data
(60) Provisional application No. 63/519,452, filed on Aug. 14, 2023.

(51) Int. Cl. F21V 8/00; G02B 13/00; G02B 27/01

(52) U.S. Cl. CPC G02B 6/0031; G02B 6/0055; G02B 13/0065; G02B 27/0172

(57) ABSTRACT

The disclosed method may include providing, by a folding mirror region of a waveguide, two or more paths for light rays from an input mirror of the waveguide to an eye box of the waveguide. The method may also include supporting, by an output mirror of the waveguide, a field of view of at least sixty degrees by at least fifty degrees. The waveguide may correspond to a two-dimensional geometrical waveguide and the folding mirror region may fit entirely within a lens shape of the waveguide. Various other methods, systems, and computer-readable media are also disclosed.

### CROSS REFERENCE TO RELATED APPLICATION

This application claims the benefit of U.S. Provisional Application No. 63/519,452, filed Aug. 14, 2023, the disclosure of which is incorporated, in its entirety, by this reference.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 illustrates an example single-path waveguide layout.

FIG. 2 illustrates an example multi-path waveguide layout.

FIG. 3 illustrates examples energy flows of a folding mirror with different mirror facets of different levels of reflectance.

FIG. 4 illustrates example paths for a single-path waveguide layout at different corners of a field of view.

FIG. 5 illustrates example paths for a multi-path waveguide layout at different corners of a field of view.

FIG. 6 illustrates an example multi-path waveguide layout with a partial reflective mirror in the folding zone.

FIG. 7 illustrates a comparison between an example single-path waveguide layout and an example multi-path waveguide layout.

FIG. 8 illustrates an example waveguide with grating.

FIG. 9 illustrates an example waveguide with organic semiconductor layer.

FIG. 10 is a flow diagram illustrating an example method in connection with a multi-path waveguide layout.

FIG. 11 is an illustration of exemplary augmented-reality glasses that may be used in connection with embodiments of this disclosure.

FIG. 12 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

Augmented reality (AR) displays may be provided in a form factor of glasses for ease of use, comfort, and style. However, large, heavy, or oddly dimensioned portions of or attachments to glasses may contribute to an AR display that is cumbersome, uncomfortable, difficult to wear, or unattractive.

In efforts to meet the design constraints imposed by the glasses form factor (including, e.g., a compact form factor in line with typical glasses), geometrical reflective AR displays may have a relatively limited field of view (e.g., 35 degrees×35 degrees or smaller). A significant constraint may be the size and shape of the folding mirror region of the waveguide layout. For example, to increase the field of view (FoV), the folding mirror region may be extended further downward to provide light paths for portions of the expanded eyebox and field of view. However, this may result in the folding mirror region extending past the desired edges of the glasses.

The devices and systems disclosed herein can achieve a relatively large field of view, even with constraints imposed a glasses form factor. In some examples, these devices and systems can achieve a field of view of approximately 60 degrees×50 degrees at all pupil positions or even 60 degrees×60 degrees at the central pupil.

In some examples, these devices and systems may include a waveguide layout providing multiple paths from the input mirror to the eyebox. In some examples, the folding mirror region may be large at points close to the input (e.g., 5 to 10 times longer than the input, or more) and small at the opposite end from the input (e.g., narrower than at the input). In some examples, the folding region close to the input mirror may have a high reflectance (e.g., around 15-30%) for initiating the multiple path recycling (initiate zone). The folding region far away the input mirror may have a high reflectance (e.g., around 15-100%) for recycling remaining energy (recycling zone) as much as possible. The folding region between the two zones (initiate and recycling zones) may have a low reflectance (e.g., around 5-10%) for passing the recycled path from the initiate zone to the recycling zone. The reflectance of the folding mirror region may be in the order of high-low-high (HLH). Furthermore, the disclosed design may improve uniformity of light across the eyebox and FoV by adding a partial reflective mirror (e.g., 10-50%) through the folding region at a depth ratio (e.g., 0.5-0.7) along the thickness direction and/or by adding a grating and a high-index layer to increase the replication density of rays (pupils). Additionally, an anisotropic material with single axis or bi-axis such as organic semiconductor (OSC) may also be laminated above the folding zone to increase the replication density.

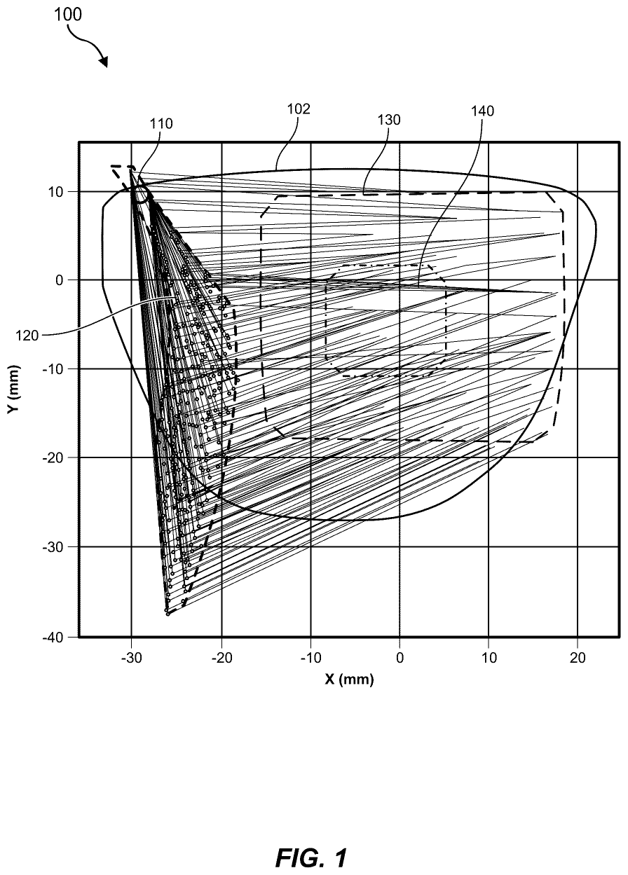

FIG. 1 illustrates an example single-path waveguide layout 100. As shown in FIG. 1, a lens shape 102 may provide a target extent of an AR display, including layout 100. Layout 100 may include an input mirror (and/or, e.g., input mirrors or prisms) 110, a folding mirror region 120, an output mirror region 130, and an eyebox 140. Mirrors in folding mirror region 120 may have an amplitude reflection coefficient r of approximately r=0.3 (reflectance of 9%) or less. Thus, the main energy flow of light rays traveling through folding mirror region 120 from the input may be in the original direction after the input, resulting in a single path for each ray to the eyebox. However, to provide sufficient light paths to achieve the field of view defined by eyebox 140, folding mirror region 120 extends past the bottom of the target extent as defined by lens shape 102.

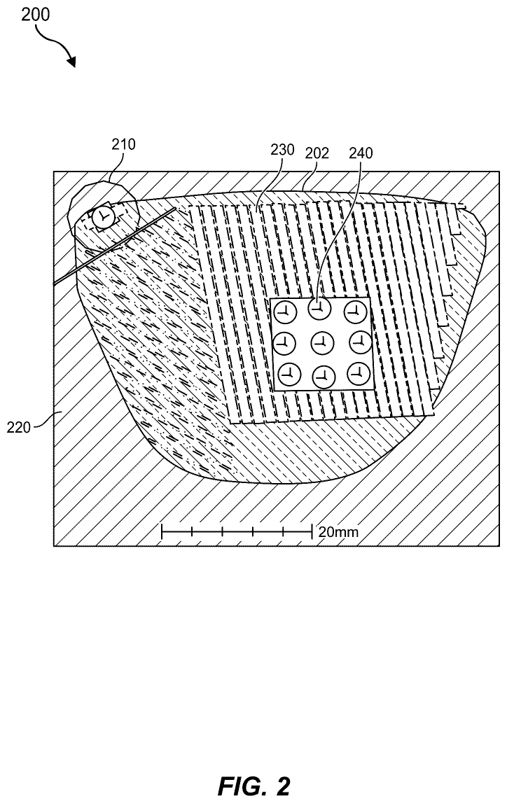

FIG. 2 illustrates an example multi-path waveguide layout 200. As shown in FIG. 2, a lens shape 202 may provide a target extent of an AR display, including layout 200. Layout 200 may include an input mirror (or input mirrors or prisms) 210, a folding mirror region 220, an output mirror 230, and an eyebox 240. In contrast to folding mirror region 120 of FIG. 1, folding mirror region 220 may provide multiple paths for rays from input mirror 210. For example, mirrors in folding mirror region 220 may have an amplitude reflection coefficient r of approximately r=0.5 (reflectance of 25%) or higher. Thus, the direction of energy flow of light rays traveling through folding mirror region 220 may have a roughly uniform distribution the input, resulting in multiple paths for each ray to the eyebox. As can be seen in FIG. 2, folding mirror region 220 may fit entirely within lens shape 202.

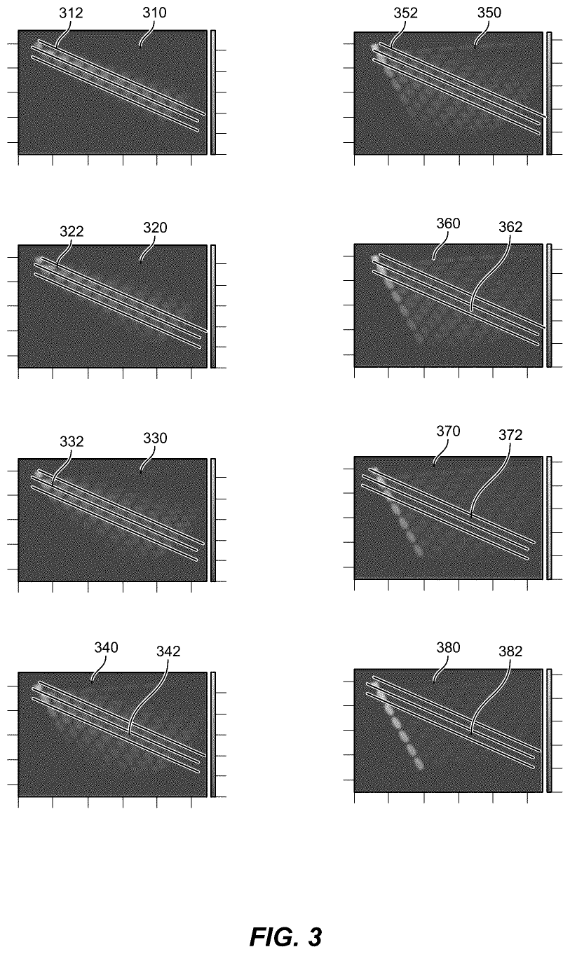

FIG. 3 illustrates example energy flows 310, 320, 330, 340, 350, 360, 370, and 380 of a folding mirror region with different mirror facets of different levels of reflectance. For example, mirror facets 312, 322, 332, 342, 352, 362, 372, and 382 may have an amplitude reflection coefficient r of approximately r=0.9, approximately r=0.8, approximately r=0.7, approximately r=0.6, approximately r=0.5, approximately r=0.4, approximately r=0.3, and approximately r=0.2, respectively. As can be seen in FIG. 3, with a higher r, energy flows closer to the angle along the mirror facets. With a lower r, energy flows more in the original direction after the input. With an r of approximately 0.4 or higher, the energy flow may provide a suitable uniformity for a multiple path design.

In some examples, devices described herein may use other diffraction elements such as a Surface Relief Grating (SRG), Polarized Volume Hologram (PVH), or a Volume Bragg Grating (VBG). In these examples, the above reflection coefficient may be applied to control the energy flow.

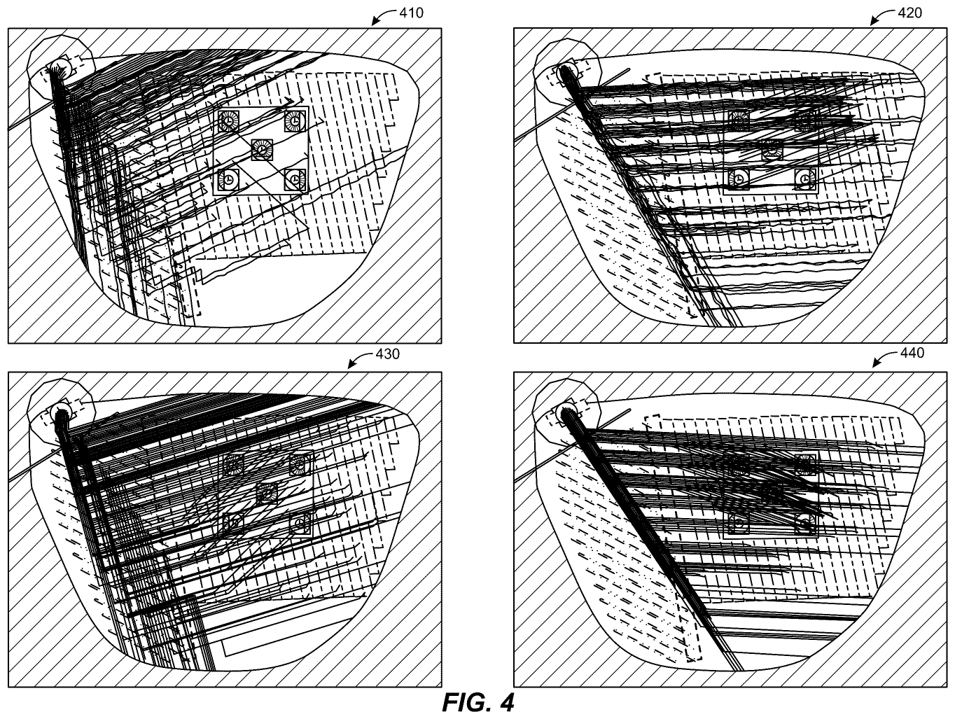

FIG. 4 illustrates example paths for a single-path waveguide layout at different corners of a field of view. For example, a path set 410 shows paths for the single-path waveguide layout at the angle [30, 20], path set 420 at angle [30, −20], path set 430 at angle [−30, 20], and path set 440 at angle [−30, −20].

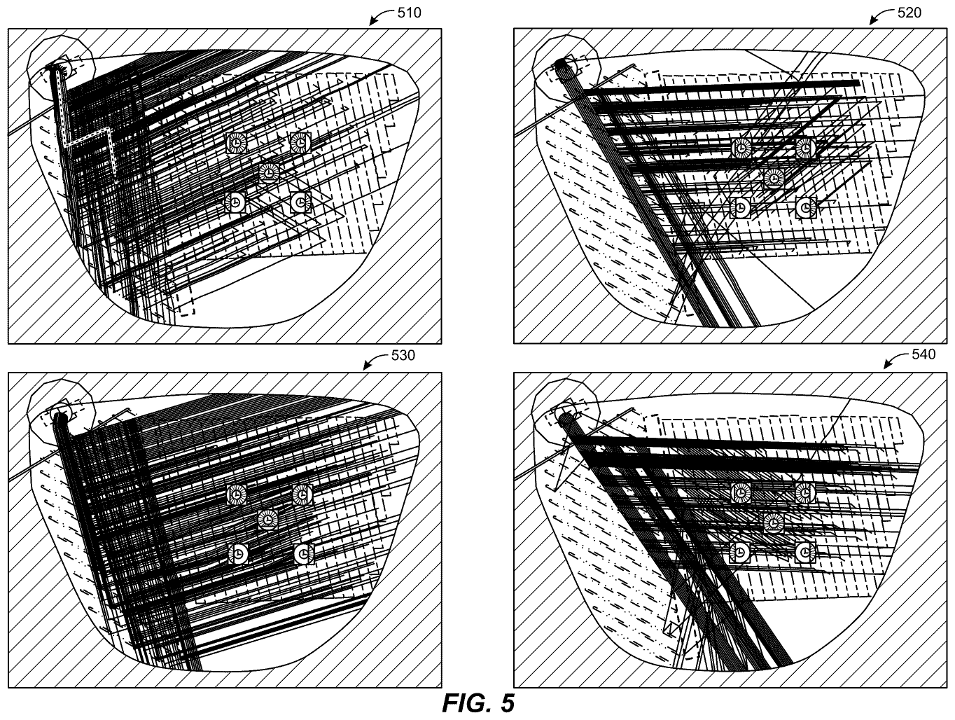

FIG. 5 illustrates example paths for a multi-path waveguide layout at different corners of a field of view. For example, a path set 510 shows paths for the single-path waveguide layout at the angle [30, 20], path set 520 at angle [30, −20], path set 530 at angle [−30, 20], and path set 540 at angle [−30, −20]. As shown in FIG. 5, in comparison with FIG. 4, folding paths for the multi-path layout may support a larger field of view. In addition, the greater number of paths may provide higher efficiency and better uniformity.

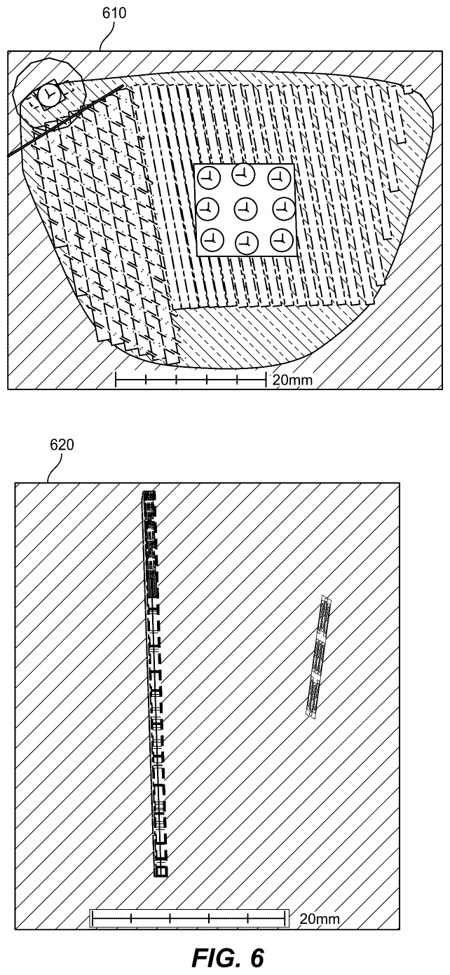

FIG. 6 illustrates an example multi-path waveguide layout 610 with a partial reflective mirror or multiple mirrors in the folding zone. A cross section view 620 is also provided. In some examples, the partial reflective mirrors may span across portions of the folding zone. In some examples, as shown in FIG. 6, the partial reflective mirrors may span substantially all or all of the folding zone. In one example, the partial reflective mirrors may have a reflectance of approximately 30-50%. In some examples, the partial reflective mirrors may be at a depth plane with a ratio of approximately the golden ratio. For example, the partial reflective mirror may be at a depth plane with a ratio of approximately 0.618. In some examples, the partial reflective mirror may be at a depth plane between approximately 0.5 and approximately 0.6.

In some examples, the partial reflective mirrors may improve uniformity of the light distribution at the eyebox and FoV, thereby mitigating, e.g., dark bands that may otherwise appear.

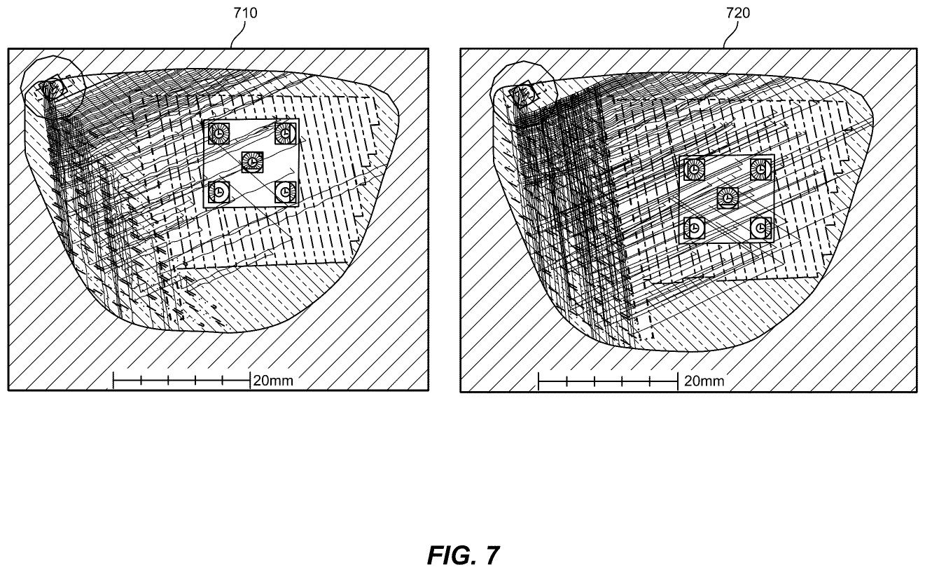

FIG. 7 illustrates a comparison between an example single-path waveguide layout 710 and an example multi-path waveguide layout 720. As shown in FIG. 7, the shape of the respective folding mirror regions may differ. For example, the folding mirror region of layout 720 may be wide near the input mirror (e.g., five times wider or more than the input mirror) rather than approximately the width of the input mirror. Furthermore, the folding mirror region of layout 720 may be as wide or wider near the input mirror than at the far side of the input mirror (at the bottom).

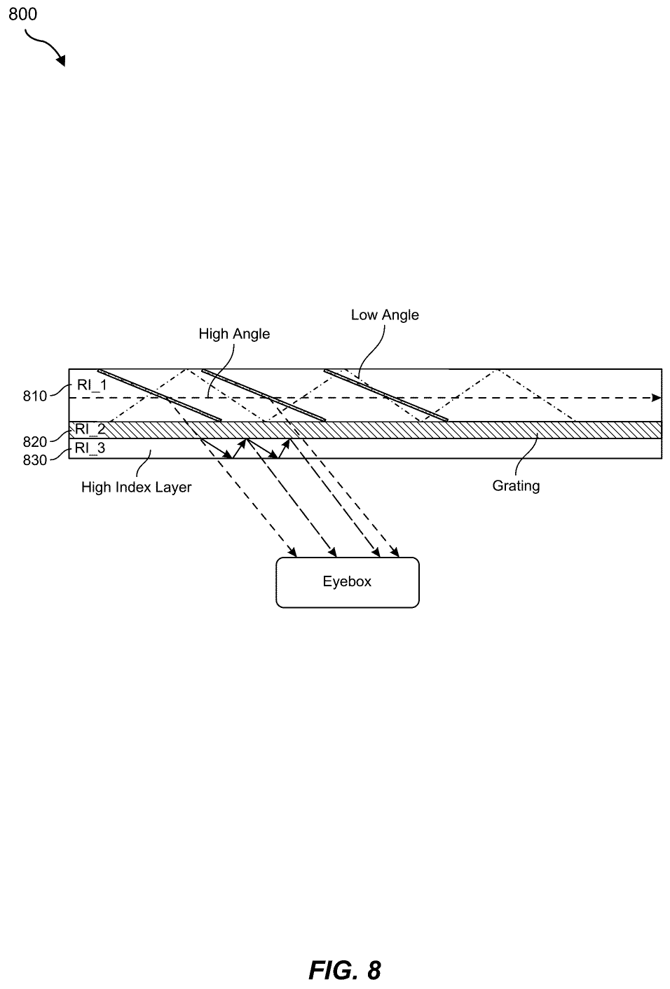

FIG. 8 illustrates an example waveguide 800 with grating. As shown in FIG. 8, waveguide 800 may include a core layer 810 (waveguide layer), a grating layer 820, and a high index layer 830 (which may be isotropic or anisotropic). Grating layer 820 and high index layer 830 may increase the replication density of rays and may mitigate non-uniformity of rays to the eyebox. In one example, grating layer 820 may have a pitch of approximately 300 nm. As depicted in FIG. 8, the refractive index of high index layer 830 may be greater than the refractive index of core layer 810, which may be much greater than the refractive index of grating layer 820.

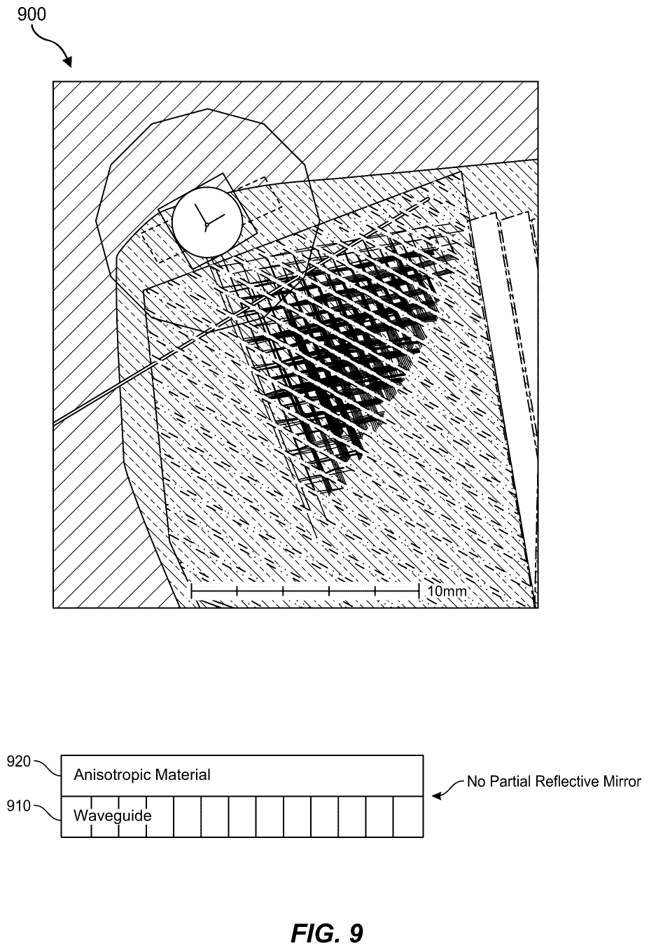

FIG. 9 illustrates an example waveguide 900 with an organic semiconductor layer. As shown in FIG. 9, waveguide 900 may include a core layer 910 (waveguide layer) and an anisotropic layer 920. Anisotropic layer 920 may increase the replication density of rays and/or may mitigate non-uniformity of rays to the eyebox.

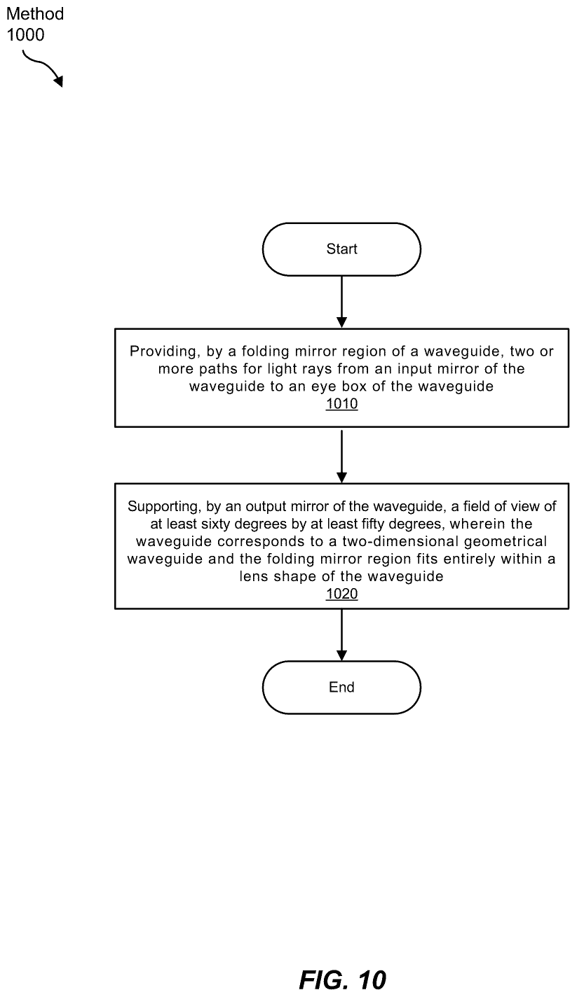

FIG. 10 illustrates an example method 1000 in connection with a multi-path waveguide layout. As illustrated in FIG. 10 at step 1010 one or more of the systems described herein may provide two or more paths for light rays. For example, a folding mirror region of a waveguide may, at step 1010, provide two or more paths for light rays from an input mirror of the waveguide to an eye box of the waveguide.

In some embodiments, the term “waveguide” may refer to a structure that guides waves by restricting the transmission of energy. Examples of waveguides may include, without limitation, a structure that guides waves by restricting the transmission of energy to one direction. Common types of waveguides include acoustic waveguides which direct sound, optical waveguides which direct light, and radio-frequency waveguides which direct electromagnetic waves other than light like radio waves. In this context, a waveguide, as used herein, may refer to an optical waveguide and a waveguide layout may refer to an arrangement of optical elements of a waveguide, such as mirrors, eye boxes, lens shapes, etc.

In some embodiments, the term “folding mirror” may refer to an optical element that changes a direction of one or more light rays propagating through a waveguide. Examples of folding mirror regions may include, without limitation, metallic or dielectric films deposited on a substrate (e.g., glass), concave mirrors, parabolic mirrors, ellipsoidal mirrors, reflective mirrors, prism mirrors, combinations thereof, etc.

In some embodiments, the term “input mirror” may refer to an optical element that directs one or more light rays (e.g., of an image) into a waveguide. Examples of input mirrors may include, without limitation, metallic or dielectric films deposited on a substrate (e.g., glass), concave mirrors, parabolic mirrors, ellipsoidal mirrors, reflective mirrors, prism mirrors, combinations thereof, etc.

In some embodiments, the term “eye box” may refer to a field of view around and along a line of sight in which an image may be seen in full. Examples of eye boxes may include, without limitation, a volume in which an eye may be located in order for a user to experience a visual percept falling within a pre-defined criterion, a volume of space in which an effectively viewable image is formed by a lens system or visual display, etc.

The systems described herein may perform step 1010 in a variety of ways. In one example, the folding mirror region may have a first size at one or more first points thereof that are proximate to the input mirror. Additionally, the folding mirror region may have a second size at one or more second points thereof that are less proximate to the input mirror than the one or more first points. In this context, the first size may be larger than the second size. In some of these implementations, the first size may be at least five times longer than a third size of the input mirror and the second size may be narrower than the third size of the input mirror. In another example, the folding mirror region may exhibit a reflectance of at least fifteen percent for multiple path recycling. In an additional example, one or more mirrors in the folding mirror region may exhibit an amplitude reflection coefficient equal to one-half. In a further example, the folding mirror region may include a partial mirror positioned in the folding mirror region at a depth plane having a ratio of 0.618.

At step 1020 one or more of the systems described herein may support a field of view. For example, an output mirror of the waveguide may, at step 1020, support a field of view of at least sixty degrees by at least fifty degrees, wherein the waveguide corresponds to a two-dimensional geometrical waveguide and the folding mirror region fits entirely within a lens shape of the waveguide.

In some embodiments, the term “field of view” may refer to a maximum area that an optical device can capture. Examples of fields of view may include, without limitation, fields of view that may be expressed in terms of horizontal degrees and vertical degrees.

In some embodiments, the term “lens shape” may refer to a region of an optical device. Examples of lens shapes may include, without limitation, shapes of AR device (e.g., glasses) lenses and/or VR (e.g., headset) lenses. In this context, lens shapes may be expressed in terms of areas and/or volumes.

The systems described herein may perform step 1020 in a variety of ways. In one example, the waveguide may include a grating and a high index layer, wherein the grating and the high index layer are configured to improve uniformity of light across the eye box by increasing a replication density of the light rays.

### EXAMPLE EMBODIMENTS

Example 1: A waveguide may include a lens shape and a folding mirror region that provides two or more paths for light rays from an input mirror to an eye box, wherein the folding mirror region fits entirely within the lens shape.

Example 2: The waveguide of Example 1, wherein the folding mirror region has a first size at one or more first points thereof that are proximate to the input mirror, the folding mirror region has a second size at one or more second points thereof that are less proximate to the input mirror than the one or more first points, and the first size is larger than the second size.

Example 3: The waveguide of Examples 1 or 2, wherein the first size is at least five times longer than a third size of the input mirror and the second size is narrower than the third size of the input mirror.

Example 4: The waveguide of Examples 1 to 3, wherein the folding mirror region exhibits a reflectance of at least fifteen percent for multiple path recycling.

Example 5: The waveguide of Examples 1 to 4, wherein one or more mirrors in the folding mirror region exhibit an amplitude reflection coefficient equal to one-half.

Example 6: The waveguide of Examples 1 to 5, wherein the folding mirror region includes a partial mirror positioned in the folding mirror region at a depth plane having a ratio of 0.618.

Example 7: The waveguide of Examples 1 to 6, further including a grating and a high index layer, wherein the grating and the high index layer are configured to improve uniformity of light across the eye box by increasing a replication density of the light rays.

Example 8: The waveguide of Examples 1 to 7, wherein the waveguide corresponds to a two-dimensional geometrical waveguide.

Example 9: The waveguide of Examples 1 to 8, further including an output mirror that supports a field of view of at least sixty degrees by at least fifty degrees.

Example 10: A system may include an input mirror, an eye box, and a folding mirror region that provides two or more paths for light rays from the input mirror to the eye box.

Example 11: The system of Example 10, wherein the folding mirror region has a first size at one or more first points thereof that are proximate to the input mirror and a second size at one or more second points thereof that are less proximate to the input mirror than the one or more first points.

Example 12: The system of Examples 10 or 11, wherein the first size is larger than the second size.

Example 13: The system of Examples 10 to 12, wherein the first size is at least five times longer than a third size of the input mirror and the second size is narrower than the third size of the input mirror.

Example 14: The system of Examples 10 to 13, wherein the folding mirror region fits entirely within a lens shape of the system.

Example 15: The system of Examples 10 to 14, wherein the folding mirror region exhibits a reflectance of at least fifteen percent for multiple path recycling.

Example 16: The system of Examples 10 to 15, wherein one or more mirrors in the folding mirror region exhibit an amplitude reflection coefficient equal to one-half.

Example 17: The system of Examples 10 to 16, wherein the folding mirror region includes a partial mirror configured to improve uniformity of light across the eye box.

Example 18: The system of Examples 10 to 17, wherein the partial mirror is positioned in the folding mirror region at a depth plane having a ratio of 0.618.

Example 19: The system of Examples 10 to 18, further including a grating and a high index layer, wherein the grating and the high index layer are configured to improve uniformity of light across the eye box by increasing a replication density of the light rays.

Example: 20: A method may include providing, by a folding mirror region of a waveguide, two or more paths for light rays from an input mirror of the waveguide to an eye box of the waveguide, and supporting, by an output mirror of the waveguide, a field of view of at least sixty degrees by at least fifty degrees, wherein the waveguide corresponds to a two-dimensional geometrical waveguide and the folding mirror region fits entirely within a lens shape of the waveguide.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

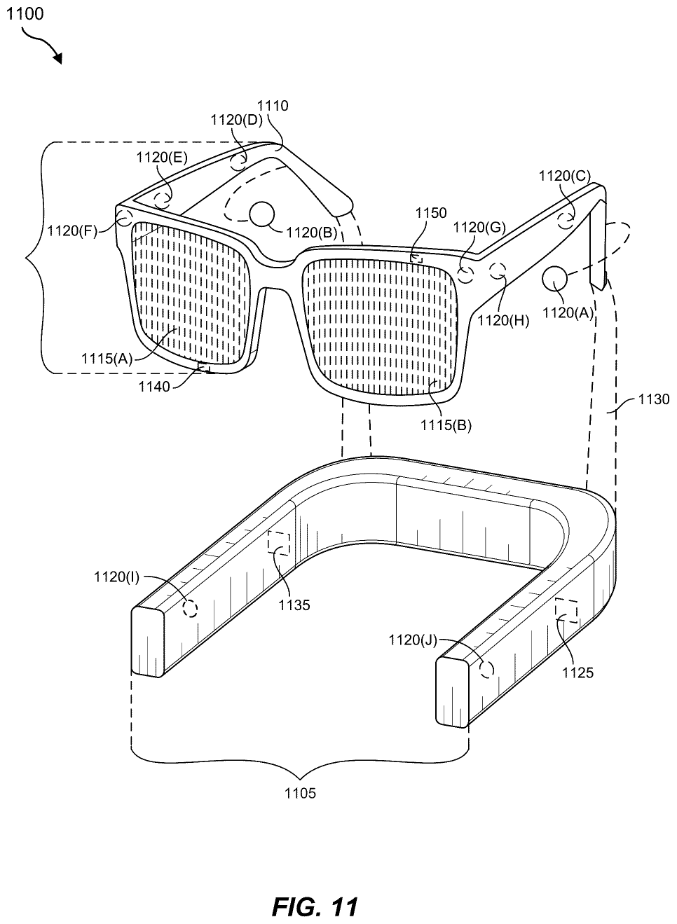

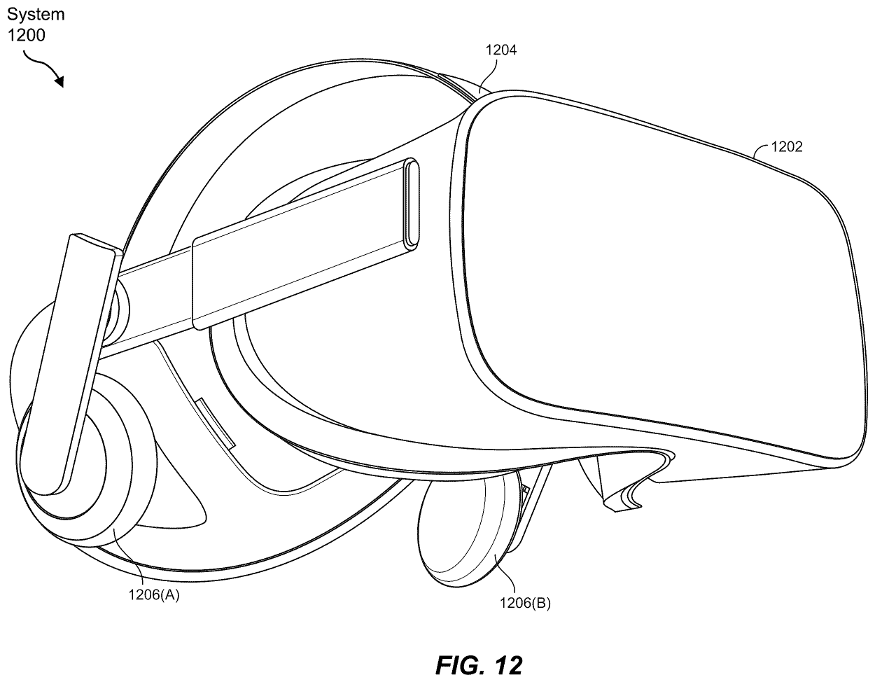

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1100 in FIG. 11) or that visually immerses a user in an artificial reality (such as, e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented-reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

In some examples, augmented-reality system 1100 may also include a microphone array with a plurality of acoustic transducers 1120(A)-1120(J), referred to collectively as acoustic transducers 1120. Acoustic transducers 1120 may represent transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(1) and 1120(J), which may be positioned on a corresponding neckband 1105.

In some embodiments, one or more of acoustic transducers 1120(A)-(J) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by an associated controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer 1120, or some combination thereof.

Acoustic transducers 1120(A) and 1120(B) may be positioned on different parts of the user's ear, such as behind the pinna, behind the tragus, and/or within the auricle or fossa. Or, there may be additional acoustic transducers 1120 on or surrounding the ear in addition to acoustic transducers 1120 inside the ear canal. Having an acoustic transducer 1120 positioned next to an ear canal of a user may enable the microphone array to collect information on how sounds arrive at the ear canal. By positioning at least two of acoustic transducers 1120 on either side of a user's head (e.g., as binaural microphones), augmented-reality system 1100 may simulate binaural hearing and capture a 3D stereo sound field around about a user's head. In some embodiments, acoustic transducers 1120(A) and 1120(B) may be connected to augmented-reality system 1100 via a wired connection 1130, and in other embodiments acoustic transducers 1120(A) and 1120(B) may be connected to augmented-reality system 1100 via a wireless connection (e.g., a BLUETOOTH connection). In still other embodiments, acoustic transducers 1120(A) and 1120(B) may not be used at all in conjunction with augmented-reality system 1100.

Acoustic transducers 1120 on frame 1110 may be positioned in a variety of different ways, including along the length of the temples, across the bridge, above or below display devices 1115(A) and 1115(B), or some combination thereof. Acoustic transducers 1120 may also be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers, other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a stand-alone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120(l) and 1120(J)) that are part of the microphone array (or potentially form their own microphone subarray). Neckband 1105 may also include a controller 1125 and a power source 1135.

Acoustic transducers 1120(1) and 1120(J) of neckband 1105 may be configured to detect sound and convert the detected sound into an electronic format (analog or digital). In the embodiment of FIG. 11, acoustic transducers 1120(1) and 1120(J) may be positioned on neckband 1105, thereby increasing the distance between the neckband acoustic transducers 1120(l) and 1120(J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120(C) and 1120(D) and the distance between acoustic transducers 1120(C) and 1120(D) is greater than, e.g., the distance between acoustic transducers 1120(D) and 1120(E), the determined source location of the detected sound may be more accurate than if the sound had been detected by acoustic transducers 1120(D) and 1120(E).

Controller 1125 of neckband 1105 may process information generated by the sensors on neckband 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1100 and/or virtual-reality system 1200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1100 and/or virtual-reality system 1200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A waveguide comprising:
a lens shape; and
a folding mirror region that provides two or more paths for light rays from an input mirror to an eye box,
wherein the folding mirror region fits entirely within the lens shape.

2. The waveguide of claim 1, wherein:
the folding mirror region has a first size at one or more first points thereof that are proximate to the input mirror;
the folding mirror region has a second size at one or more second points thereof that are less proximate to the input mirror than the one or more first points; and
the first size is larger than the second size.

3. The waveguide of claim 2, wherein the first size is at least five times longer than a third size of the input mirror and the second size is narrower than the third size of the input mirror.

4. The waveguide of claim 1, wherein the folding mirror region exhibits a reflectance of at least fifteen percent for multiple path recycling.

5. The waveguide of claim 1, wherein one or more mirrors in the folding mirror region exhibit an amplitude reflection coefficient equal to one-half.

6. The waveguide of claim 1, wherein the folding mirror region includes a partial mirror positioned in the folding mirror region at a depth plane having a ratio of 0.618.

7. The waveguide of claim 1, further comprising:
a grating; and
a high index layer,
wherein the grating and the high index layer are configured to improve uniformity of light across the eye box by increasing a replication density of the light rays.

8. The waveguide of claim 1, wherein the waveguide corresponds to a two-dimensional geometrical waveguide.

9. The waveguide of claim 1, further comprising:
an output mirror that supports a field of view of at least sixty degrees by at least fifty degrees.

10. A system comprising:
an input mirror;
an eye box; and
a folding mirror region that provides two or more paths for light rays from the input mirror to the eye box.

11. The system of claim 10, wherein the folding mirror region has a first size at one or more first points thereof that are proximate to the input mirror and a second size at one or more second points thereof that are less proximate to the input mirror than the one or more first points.

12. The system of claim 11, wherein the first size is larger than the second size.

13. The system of claim 12, wherein the first size is at least five times longer than a third size of the input mirror and the second size is narrower than the third size of the input mirror.

14. The system of claim 10, wherein the folding mirror region fits entirely within a lens shape of the system.

15. The system of claim 10, wherein the folding mirror region exhibits a reflectance of at least fifteen percent for multiple path recycling.

16. The system of claim 10, wherein one or more mirrors in the folding mirror region exhibit an amplitude reflection coefficient equal to one-half.

17. The system of claim 10, wherein the folding mirror region includes a partial mirror configured to improve uniformity of light across the eye box.

18. The system of claim 17, wherein the partial mirror is positioned in the folding mirror region at a depth plane having a ratio of 0.618.

19. The system of claim 10, further comprising:
a grating; and
a high index layer,
wherein the grating and the high index layer are configured to improve uniformity of light across the eye box by increasing a replication density of the light rays.

20. A method comprising:
providing, by a folding mirror region of a waveguide, two or more paths for light rays from an input mirror of the waveguide to an eye box of the waveguide; and
supporting, by an output mirror of the waveguide, a field of view of at least sixty degrees by at least fifty degrees,
wherein the waveguide corresponds to a two-dimensional geometrical waveguide and the folding mirror region fits entirely within a lens shape of the waveguide.
